(19) United States
(12) Patent Application Publication
(10) Pub. No.: US 2012/0097781 A1
(43) Pub. Date: Apr. 26, 2012

(54) SEAT BELT RETRACTOR WITH DEEP DRAWN SPOOL

(75) Inventors: Michael W. Jagenow, Almont, MI (US); Scott M. Franz, Clinton Township, MI (US)

(73) Assignee: TRW Vehicle Safety Systems Inc.

(21) Appl. No.: 12/911,785

(22) Filed: Oct. 26, 2010

(51) Int. Cl. B60R 22/34; B60R 22/28

(52) U.S. Cl. 242/376

(57) ABSTRACT

A seat belt retractor (10) includes a spool member (46) on which seat belt webbing (16) is wound. The spool member (46) is supported for rotation in a belt withdrawal direction (58) and an opposite belt retraction direction (60). The spool member (46) has an open end (56) and a closed end (54) spaced apart along the axis. A length of the spool member (46) extends from the open end (56) to the closed end (54). The spool member (46) is hollow and has a radially inner surface (102) and a radially outer surface (104). The radially outer surface (104) extends for the length of the spool member (46) and receives the seat belt webbing (16). The radially inner surface (102) extends for substantially the length of the spool member (46). A wall (106) of the spool member (46) is defined between the radially inner and outer surfaces (102, 104). The wall (106) has a thickness that is substantially constant along the radially inner surface (102).

### TECHNICAL FIELD

The present invention relates to a seat belt retractor. More particularly, the present invention relates to a seat belt retractor that includes a deep drawn spool on which seat belt webbing is wound.

### BACKGROUND OF THE INVENTION

A vehicle seat belt retractor includes a spool on which seat belt webbing is wound. A spool locking mechanism for the retractor includes a ratchet rotatable with the spool and a pawl. The spool may be a die cast part, and the ratchet may be formed in one piece with the spool by die casting, as described, for example, in Schmid et al U.S. Pat. No. 5,593,105. The pawl is movable into engagement with the ratchet to block rotation of the ratchet and the spool. Actuation of the spool locking mechanism blocks withdrawal of seat belt webbing from the spool to help protect a vehicle occupant in the event of a vehicle collision.

A seat belt retractor may also include a torsion bar to help manage the loads on the vehicle occupant in a vehicle collision. Such a torsion bar acts between the spool and the ratchet. When the spool locking mechanism is actuated, and the occupant moves forward against the seat belt webbing with sufficient force, the kinetic energy of the occupant is transmitted through the spool into the torsion bar and the ratchet. The torsion bar begins to twist when a given load is applied to the belt webbing. The twisting of the torsion bar allows the spool to rotate relative to the ratchet and allows a small amount of belt webbing to pay out. This release of belt webbing permits a small amount of additional forward movement of the vehicle occupant and reduces the peak load on the occupant. Ebner et al. U.S. Pat. No. 5,526,996 discloses a retractor with a torsion bar that extends through a passage formed lengthwise in the center of the retractor spool.

### SUMMARY OF THE INVENTION

The present invention is directed to a seat belt retractor and, more particularly, to a seat belt retractor that includes a deep drawn spool on which seat belt webbing is wound.

In accordance with one representative embodiment of the present invention, a seat belt webbing retractor comprises a spool member on which seat belt webbing is wound. The spool member is supported for rotation about an axis in a belt retraction direction and an opposite belt withdrawal direction. The spool member has an open end and a closed end spaced apart along the axis. A length of the spool member extends from the open end to the closed end. The spool member is hollow and has a radially inner surface and a radially outer surface. The radially outer surface extends for the length of the spool member and receives the seat belt webbing. The radially inner surface extends for substantially the length of the spool member. A wall of the spool member is defined between the radially inner and outer surfaces. The wall has a thickness that is substantially constant along the radially inner surface.

In accordance with another embodiment of the present invention, a seat belt webbing retractor comprises a spool member on which seat belt webbing is wound. The spool member is supported for rotation about an axis in a belt retraction direction and an opposite belt withdrawal direction. The spool member has an open end and a closed end spaced apart along the axis. A length of the spool member extends from the open end to the closed end. The spool member is hollow and has a radially inner surface and a radially outer surface. The radially outer surface extends for the length of the spool member and receives the seat belt webbing. The radially inner surface extends for substantially the length of the spool member. A wall of the spool member is defined between the radially inner and outer surfaces. The wall has a thickness that is substantially constant along the radially inner surface. The retractor also comprises a plastically deformable torsion bar, which has a first end portion and a second end portion. The first end portion of the torsion bar is rotatable relative to the second end portion. The torsion bar twists upon rotation of the first end portion relative to the second end portion. The retractor further comprises an actuatable spool locking mechanism for when actuated blocking rotation of the spool member in the belt withdrawal direction. The spool locking mechanism includes a ratchet member and a pawl movable into locking engagement with the ratchet member to block rotation of the ratchet member. The closed end of the spool member is fixed for rotation with the first end portion of the torsion bar, and the ratchet member is fixed for rotation with the second end portion of the torsion bar. The torsion bar thereby resists rotation of the spool member relative to the ratchet member. The torsion bar twists and the spool member rotates in the belt withdrawal direction relative to the ratchet member when the spool locking mechanism is actuated and a tensile force is applied to the spool member by the seat belt webbing in an amount exceeding a predetermined amount.

In accordance with still another embodiment of the present invention, a seat belt webbing retractor comprises a spool member on which seat belt webbing is wound. The spool member is supported for rotation about an axis in a belt retraction direction and an opposite belt withdrawal direction. The spool member has a first end and a second end spaced apart along the axis. A length of the spool member extends from the first end to the second end. The spool member is hollow and has a radially inner surface and a radially outer surface. The radially outer surface extends for the length of the spool member and receives the seat belt webbing. The radially inner surface extends for substantially the length of the spool member. The spool member is a deep drawn member.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic illustration of a vehicle seat belt system including a retractor constructed in accordance with the present invention;

FIG. 2 is a longitudinal sectional view of the retractor of FIG. 1; and

FIG. 3 is a partially-exploded, perspective view of the retractor of FIG. 1.

### DESCRIPTION OF EMBODIMENT

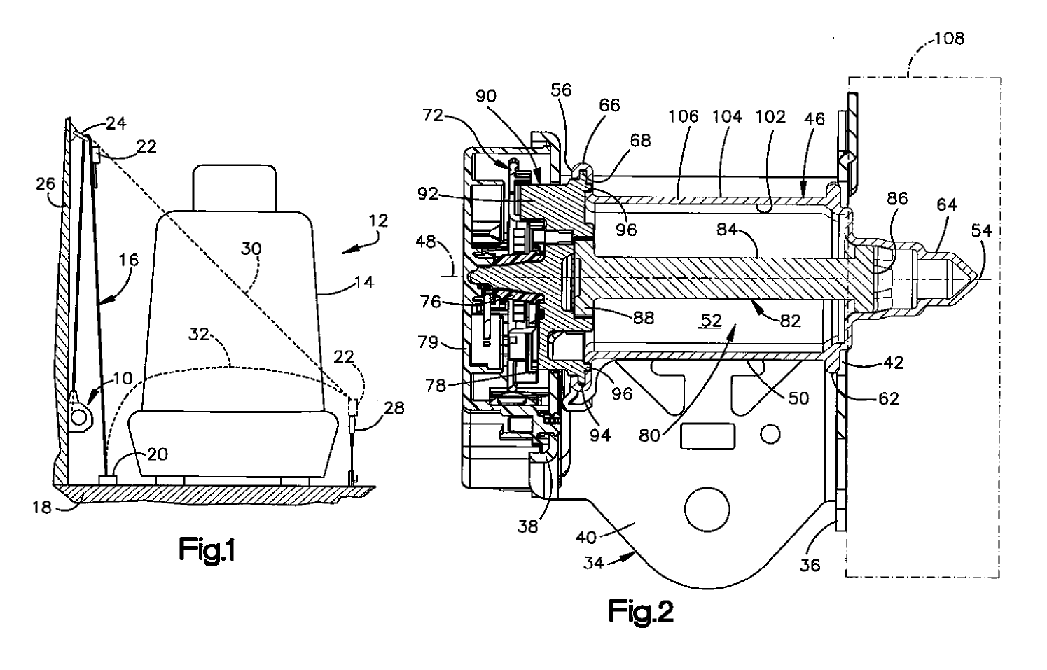

The present invention relates to a vehicle seat belt retractor and is applicable to various seat belt retractors. As representative of the invention, FIG. 1 illustrates a seat belt retractor 10, which forms part of a three-point continuous loop seat belt system 12 for use in helping to protect an occupant (not shown) of a vehicle.

The occupant of the vehicle sits on a vehicle seat 14, which is illustrated as a front passenger seat in the vehicle. A length of seat belt webbing 16 is extensible about the vehicle occupant. One end of the length of belt webbing 16 is anchored to the vehicle body 18 at an anchor point 20 located on one side of the seat 14. The opposite end of the belt webbing 16 is attached to the retractor 10, which is secured to the vehicle B-pillar 26 on the same side of the seat 14. intermediate its ends, the belt webbing 16 passes through a tongue assembly 22 and a D-ring or turning loop 24 that is mounted to the B-pillar 26 above the retractor 10 and the anchor point 20. When the seat belt system 12 is not in use, the belt webbing 16 is wound on the retractor 10 and is oriented generally vertically on the one side of the seat 14, as shown in solid lines in FIG. 1.

To engage the seat belt system 12, the tongue assembly 22 is manually grasped and is pulled across the lap and torso of the occupant sitting in the seat 14. As the tongue assembly 22 is pulled across the lap and torso of the occupant, the tongue assembly moves along the belt webbing 16, and the belt webbing is unwound from the retractor 10. When the belt webbing 16 has been pulled across the lap and torso of the occupant, the tongue assembly 22 is connected with a buckle 28, as shown in dashed lines in FIG. 1. The buckle 28 is connected to the vehicle body 18 and is disposed on the side of the seat 14 opposite the anchor point 20. When the seat belt system 12 is thus buckled, the length of belt webbing 16 is divided by the tongue assembly 22 into a torso portion 30, which extends across the torso of the occupant, and a lap portion 32, which extends across the lap of the occupant.

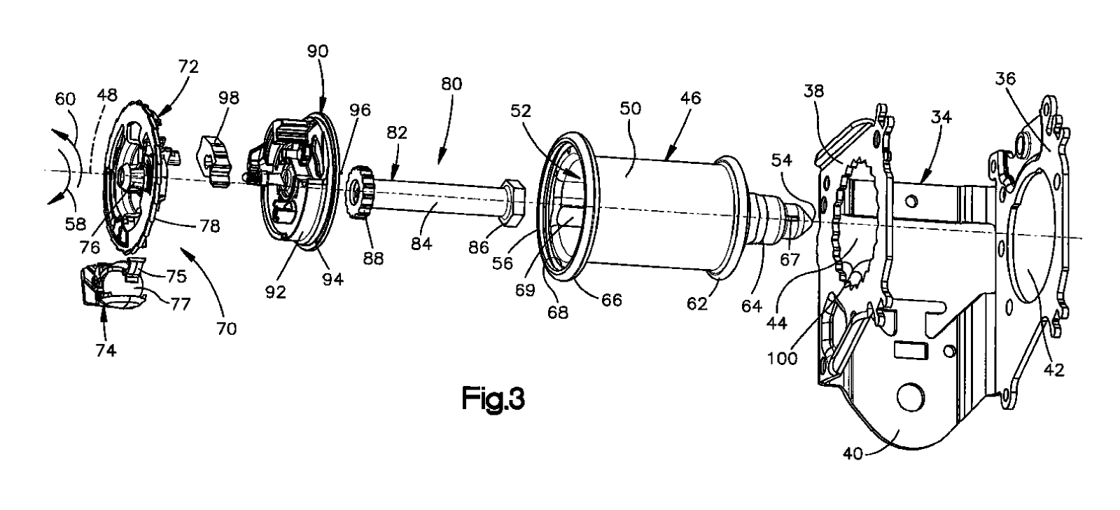

The seat belt retractor 10 includes a base 34 (FIGS. 2 and 3), which is secured to the B-pillar 26 in a manner that is not shown. The base 34 is fabricated of metal, such as steel, or other material capable of withstanding loads applied to the retractor 10 during, for example, a vehicle collision. The base 34 is generally U-shaped with first and second side portions 36 and 38, respectively, spaced apart from one another and projecting away from opposite ends of an intermediate portion 40. The first side portion 36 has an opening 42 (FIG. 3) formed in it, and the second side portion 38 has an opening 44 formed in it. The base 34 supports a spool member or spool 46 on which the seat belt webbing 16 can be wound. In particular, the base 34 supports the spool 46 for rotation relative to the base 34 about an axis 48 that extends longitudinally of and through the center of the spool.

The spool 46 is made from a material, such as steel, that can be formed into a relatively thin-walled and strong structure, as will be described in further detail below. The spool 46 has a hollow body portion 50 through which a central passage 52 extends. A first end 54 of the spool 46 is closed, and an opposite, second end 56 of the spool 46 is open. The length of the spool 46 extends between the first and second ends 54 and 56. Adjacent the closed first end 54, the body portion 50 of the spool 46 includes a radially outwardly extending ridge 62 and an axially extending, hollow, tapered projection 64. Adjacent the open second end 56, the body portion 50 of the spool 46 includes a radially outwardly extending lip 66 that is bent back upon itself to provide a radially inwardly facing groove 68.

The seat belt webbing 16 is wound on the hollow body portion 50 of the spool 46 between the ridge 62 and the lip 66. The ridge 62 and the lip 66 help to guide the seat belt webbing 16 as it is wound on and unwound from the spool 46. One end (not shown) of the seat belt webbing 16 is formed in a loop and is attached to the spool 46 by passing through an elongated slot 69 formed in the body portion 50. The loop (not shown) in the seat belt webbing 16 is disposed in the central passage 52 of the spool 46 and receives a pin or plate (not shown) that is too large to pass through the elongated slot 69, thereby retaining seat belt webbing on the spool.

The spool 46 is mounted on the base 34 with the tapered projection 64 extending through the opening 42 in the first side portion 36 and the lip 66 disposed adjacent to the opening 44 in the second side portion 38. The spool 46 is rotatable relative to the base 34 about the axis 48 in a belt webbing withdrawal direction 58 and an opposite belt webbing retraction direction 60, which are indicated by arrows in FIG. 3. The retractor 10 includes a rewind spring (not shown), which acts between the base 34 and the spool 46 to bias the spool to rotate in the belt webbing retraction direction 60. One end of the rewind spring (not shown) is attached to the spool 46 via a slot 67 formed in the tapered projection 64. The other end of the rewind spring is attached to the base 34.

The retractor 10 also includes a spool locking mechanism 70. The spool locking mechanism 70 includes a clutch disk or ratchet 72 and a pawl assembly 74. The pawl assembly 74 is mounted on the base 34 and includes a pivotable plastic cap 75 resting on a movable inertia member 77, such as a steel ball. The ratchet 72 may be made from plastic or metal and is supported for rotation relative to the base 34. The ratchet 72 has a hub portion 76 and a toothed outer peripheral portion 78. The outer peripheral portion 78 of the ratchet 72 is engageable by the pawl assembly 74 to block rotation of the ratchet about the axis 48 in the belt withdrawal direction 58. This engagement, in a manner described below, also blocks rotation of the spool 46 in the belt withdrawal direction 58. Both the ratchet 72 and the pawl assembly 74 are protected from the environment by a plastic cover 79 attached to the base 34.

The retractor 10 further includes an energy management device 80. The energy management device 80 includes a torsion bar 82 disposed in the central passage 52 of the spool 46. The torsion bar 82 is made from a material, such as a ductile metal, that enables the torsion bar to be twisted about its longitudinal axis, which is coaxial with the axis 48, up to five or six times without breaking. The torsion bar 82 has an elongate cylindrical main body portion 84, which is centered on the axis 48, and first and second end portions 86 and 88.

The first end portion 86 of the torsion bar 82 is secured by a mechanical interlocking connection, such as mating hexagonal, pentagonal, or other geometric shapes, to the tapered projection 64 adjacent to the closed first end 54 of the spool 46. The first end portion 86 of the torsion bar 82 is thereby fixed for rotation with the spool 46, about the axis 48, relative to the base 34. The first side portion 36 of the base 34 supports, via a bearing member (not shown), the closed first end 54 of the spool 46 and thus the first end portion 86 of the torsion bar 82 for rotation about the axis 48 relative to the base 34.

The opposite second end portion 88 of the torsion bar 82 is fixed for rotation, via splines or other connecting structure, with a disk gear or disc-shaped end member 90. The end member 90 is disposed adjacent the second end 56 of the spool 46. The second side portion 38 of the base 34 supports the end member 90 and, thereby, the second end 56 of the spool 46 and the second end portion 88 of the torsion bar 82 for rotation about the axis 48 relative to the base 34.

The end member 90 is fabricated of metal, such as steel, or other material capable of withstanding loads applied to the retractor 10 during, for example, a vehicle collision. The end member 90 includes a centrally located body portion 92, which extends toward and contacts the plastic cover 79, and a peripheral flange 94, which extends radially outward from the body portion 92. The peripheral flange 94 is received in the groove 68 formed by the lip 66 adjacent the open second end 56 of the spool 46. Although the lip 66 fits closely about the peripheral flange 94, the lip and the peripheral flange are spaced apart a small distance to permit the end member 90 to rotate about the axis 48 relative to the spool 46. Frangible pins 96 formed in one piece with the end member 90 extend from the end member into aligned openings in the lip 66 of the spool 46. The frangible pins 96 block relative rotation between the end member 90 and the spool 46 under normal conditions.

The body portion 92 of the end member 90 supports the ratchet 72 for rotation relative to the end member about the axis 48. The body portion 92 of the end member 90 also mounts a locking pawl 98 for pivotal movement relative to the end member. The locking pawl 98 is fabricated of metal, such as steel, or other material capable of withstanding loads applied to the retractor 10 during, for example, a vehicle collision.

The torsion bar 82 connects the spool 46 and the end member 90, as well as the ratchet 72, in a force-transmitting relationship, coupling them together for rotation about the axis 48. So long as the torsion bar 82 is not twisting about its own longitudinal axis, the spool 46, the torsion bar, the end member 90, and the ratchet 72 rotate together about the axis 48 as a unit. Consequently, when the pawl assembly 74 engages the ratchet 72, which blocks rotation of the ratchet about the axis 48 in the belt withdrawal direction 58, the engagement between the pawl assembly and the ratchet normally also blocks rotation of the spool 46 about the axis 48.

More specifically, in normal operation of the retractor 10, the spool 46 rotates relative to the base 34 under the influence of forces applied by the belt webbing 16 and the retractor's rewind spring (not shown). The torsion bar 82 transmits the rotation of the spool 46 to the ratchet 72, and the ratchet rotates with the spool.

In certain circumstances, such as rapid vehicle deceleration, which leads to rapid forward movement of the vehicle occupant against the torso portion 30 of the belt webbing 16, the pawl assembly 74 is moved, in a known manner, into engagement with the ratchet 72. The engagement of the pawl assembly 74 with the ratchet 72 blocks rotation of the ratchet in the belt withdrawal direction 58.

When the ratchet 72 is blocked from rotation in the belt withdrawal direction 58, the spool 46 and the end member 90 will nonetheless tend to rotate in the belt withdrawal direction under influence of the load applied by the rapid forward movement of the vehicle occupant against the torso portion 30 of the belt webbing 16. The resulting relative movement between the ratchet 72 and the end member 90 causes a projection (not shown) formed on the ratchet to urge the locking pawl 98 to pivot in a radially outward direction toward the adjacent second side portion 38 of the base 34. As it pivots, the locking pawl 98 engages locking teeth 100 formed in the second side portion 38 and arranged in a circular array about the opening 44 in the second side portion. Engagement between the locking pawl 98 and the locking teeth 100 blocks the end member 90 from rotation in the belt withdrawal direction 58. The torsion bar 82 and the frangible pins 96 resist relative rotation between the spool 46 and the end member 90. The spool 46 is thus blocked from rotation relative to the base 34 in the belt withdrawal direction 58.

If rapid vehicle deceleration, for example, results from a vehicle collision for which actuation of the energy management device 80 is desired, relative rotation is permitted between the end member 90 and the adjacent open second end 56 of the spool 46. The relative rotation is permitted by breaking the frangible pins 96 and twisting the torsion bar 82. More specifically, the frangible pins 96 are constructed and configured to break when the spool locking mechanism 70 is actuated, the locking pawl 98 engages the locking teeth 100, and a tensile force greater than a predetermined force is applied to the belt webbing 16, and thus to the spool 46. When the frangible pins 96 break, the second end 56 of the spool 46 can rotate relative to the end member 90, the second end portion 88 of the torsion bar 82, and the base 34 to permit rotation of the spool 46 in the belt withdrawal direction 58. The predetermined force is selected to be a force that is experienced only when it is desired to actuate the energy management device 80, such as during a vehicle collision, and not during normal use of the seat belt system 12.

When tensile force in an amount exceeding the predetermined force is applied through the belt webbing 16 to the spool 46, the force is transmitted through the tapered projection 64 adjacent the first end 54 of the spool into the first end portion 86 of the torsion bar 82. The first end portion 86 of the torsion bar 82 rotates with the tapered projection 64 of the spool 46 because of the mechanical interlocking connection between the first end portion and the tapered projection. At the same time, the tensile force is sufficient to break the frangible pins 96, and the second end 56 of the spool 46 is free to rotate relative to the second end portion 88 of the torsion bar 82.

Because the second end portion 88 of the torsion bar 82 is blocked from rotation by the engagement of the locking pawl 98 with the locking teeth 100, the torsion bar twists about its longitudinal axis. The torsion bar 82 thus deforms plastically so that the first end portion 86 rotates relative to the second end portion 88. Twisting of the torsion bar 82 permits rotation of the spool 46 relative to the base 34 and permits a small amount of belt webbing 16 to be unwound from the spool. The occupant's forward movement against the belt webbing 16 is restrained at a reduced rate over an increased period of time, helping to reduce the maximum load experienced by the vehicle occupant.

To enable the spool 46 to transmit loads from the seat belt webbing 16 to the torsion bar 82 when actuation of the energy management device 80 is desired, the spool must be strong enough to transmit the loads while resisting twisting. The spool 46 must also have an inner diameter sufficiently large to permit the central passage 52 to accommodate the energy management device 80, while having an outer diameter sufficiently small to keep the maximum diameter of the seat belt webbing 16, when fully wound on the spool, as small as possible.

To help achieve the foregoing, the spool 46 is formed as a one-piece member from a single piece of metal or other material using a deep drawing or comparable process. This permits the spool 46 to have a relatively large internal diameter and a relatively small outer diameter. More specifically, as best shown in FIG. 2, the spool 46 has a radially inner surface 102, a radially outer surface 104, and a wall 106 defined between the radially inner and outer surfaces. The radially outer surface 104 extends for the length of the spool 46 from the closed first end 54 to the open second end 56. The radially inner surface 102 extends for substantially the length of the spool 46 from the inner side of body portion 50 at the closed first end 54 of the spool to the open second end 56 of the spool.

The wall 106 has a thickness, measured between the radially inner and outer surfaces 102 and 104, respectively, and generally radially of the spool 46, which is substantially constant along the length of the radially inner surface 102. As illustrated in FIG. 2, the thickness of the wall 106 varies from a constant value only adjacent the ridge 62 and adjacent a point approximately halfway along the tapered projection 64, at which an internal ridge with a right-angled corner is formed. The thickness of the wall 106 is desirably less than about 3 mm and substantially less than about 10 mm, which is the minimum wall thickness of at least some known die cast spools.

From the above description of the invention, those skilled in the art will perceive improvements, changes and modifications in the invention. For example, the retractor 10 may include (a) both a torsion bar 82 and one or more other ancillary mechanisms, such as a pretensioner 108, (b) one or more other ancillary mechanisms, such as a pretensioner, without a torsion bar, or (c) neither a torsion bar nor any other ancillary mechanism. If the retractor 10 includes a pretensioner 108, the pretensioner may be operated by a spring, a pyrotechnic charge, a small electric motor, or other suitable actuator and may interact with the torsion bar 82 through various different connection mechanisms, as known in the art. Also, while the locking pawl 98 has been described and illustrated as being mounted on the end member 90 and the locking teeth 100 have been described and illustrated as being formed on the base 34, the positions of the locking pawl 98 and the locking teeth 100 could be reversed. The locking pawl 98 would then be pivotally mounted on the base 34, and the locking teeth would be formed on the end member 90. Such improvements, changes and modifications within the skill of the art are intended to be covered by the appended claims.

Having described the invention, the following is claimed:

1. A seat belt webbing retractor comprising:
a spool member on which seat belt webbing is wound, the spool member being supported for rotation about an axis in a belt retraction direction and an opposite belt withdrawal direction,
the spool member having an open end and a closed end spaced apart along the axis, a length of the spool member extending from the open end to the closed end, the spool member being hollow and having a radially inner surface and a radially outer surface, the radially outer surface extending for the length of the spool member and receiving the seat belt webbing, the radially inner surface extending for substantially the length of the spool member, a wall of the spool member being defined between the radially inner and outer surfaces, the wall having a thickness that is substantially constant along the radially inner surface.

2. A retractor as set forth in claim 1 wherein the spool member is formed as a one-piece member.

3. A retractor as set forth in claim 1 wherein the thickness of the wall of the spool member is less than about 3 mm.

4. A retractor as set forth in claim 1 wherein the spool member is a deep drawn member.

5. A retractor as set forth in claim 1 further comprising a plastically deformable torsion bar having a first end portion and a second end portion, the first end portion of said torsion bar being rotatable relative to the second end portion, the torsion bar twisting upon rotation of the first end portion relative to the second end portion, the first end portion of the torsion bar being fixed to the closed end of the spool.

6. A seat belt webbing retractor comprising:
a spool member on which seat belt webbing is wound, the spool member being supported for rotation about an axis in a belt retraction direction and an opposite belt withdrawal direction, the spool member having an open end and a closed end spaced apart along the axis, a length of the spool member extending from the open end to the closed end, the spool member being hollow and having a radially inner surface and a radially outer surface, the radially outer surface extending for the length of the spool member and receiving the seat belt webbing, the radially inner surface extending for substantially the length of the spool member, a wall of the spool member being defined between the radially inner and outer surfaces, the wall having a thickness that is substantially constant along the radially inner surface;
a plastically deformable torsion bar having a first end portion and a second end portion, the first end portion of the torsion bar being rotatable relative to the second end portion, the torsion bar twisting upon rotation of the first end portion relative to the second end portion;
an actuatable spool locking mechanism for when actuated blocking rotation of the spool member in the belt withdrawal direction, the spool locking mechanism including a ratchet member and a pawl movable into locking engagement with the ratchet member to block rotation of the ratchet member;
the closed end of the spool member being fixed for rotation with the first end portion of the torsion bar and the ratchet member being fixed for rotation with the second end portion of the torsion bar, the torsion bar thereby resisting rotation of the spool member relative to the ratchet member;
the torsion bar twisting and the spool member rotating in the belt withdrawal direction relative to the ratchet member when the spool locking mechanism is actuated and a tensile force is applied to the spool member by the seat belt webbing in an amount exceeding a predetermined amount.

7. A seat belt webbing retractor comprising:
a spool member on which seat belt webbing is wound, the spool member being supported for rotation about an axis in a belt retraction direction and an opposite belt withdrawal direction;
the spool member having a first end and a second end spaced apart along the axis, a length of the spool member extending from the first end to the second end, the spool member being hollow and having a radially inner surface and a radially outer surface, the radially outer surface extending for the length of the spool member and receiving the seat belt webbing, the radially inner surface extending for substantially the length of the spool member, the spool member being a deep drawn member.
